(19) United States
(12) Patent Application Publication
(10) Pub. No.: US 2005/0137314 A1
(43) Pub. Date: Jun. 23, 2005

(54) Tire with innerliner for prevention of vapor permeation

(76) Inventor: Leighton Randolph Spadone, Beachwood, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/738,580

(22) Filed: Dec. 17, 2003

(51) Int. Cl. B60C 5/14; B60C 1/00; C08K 3/34; C08K 3/04

(52) U.S. Cl. 524/492; 152/510; 156/123; 524/495

(57) ABSTRACT

The present invention relates to a pneumatic tire having a layer, preferably an innerliner, for prevention, or retardation, of air/moisture vapor permeation from its inner chamber into the remainder of the tire. The innerliner is an isobutylene copolymer elastomer-based composition which contains a dispersion of carbon black and precipitated silica reinforcement together with a coupling agent. In one aspect, the coupling agent is a bis(3-triethoxysilylpropyl) polysulfide which contains an average of from about 2 to about 4, preferably from about 2 to about 2.6, connecting sulfur atoms in its polysulfidic bridge. In another aspect, the coupling agent is blended with the composition in a productive mixing stage.

### FIELD OF THE INVENTION

The present invention relates to a pneumatic tire having a layer, preferably an innerliner, for prevention, or retardation, of air/moisture vapor permeation from its inner chamber into the remainder of the tire. The innerliner is an isobutylene copolymer elastomer-based composition which contains a dispersion of carbon black and precipitated silica reinforcement together with a coupling agent. In one aspect, the coupling agent is a bis(3-triethoxysilylpropyl) polysulfide which contains an average of from about 2 to about 4, preferably from about 2 to about 2.6, connecting sulfur atoms in its polysulfidic bridge. In another aspect, the coupling agent is blended with the composition in a productive mixing stage.

### BACKGROUND OF THE INVENTION

A pneumatic rubber tire is conventionally of a toroidal shape and comprised of a carcass with a cavity in which its closure is typically completed with a rigid rim onto which the tire is to be mounted. Such pneumatic tire and pneumatic tire/rim assembly is well known.

The inner surface of a pneumatic tire, namely a surface of said cavity which is sometimes referred to as an “innerliner” is typically a rubber layer composed of an elastomeric composition designed to prevent, or retard, the permeation of air and moisture into the tire carcass from the aforesaid cavity which becomes the tire's inner air chamber. Such tire innerliners, or innerliner rubber layers, are well to those having skill in such art.

Butyl rubber is typically relatively impermeable to air and moisture and is often used as a major portion of the tire innerliner composition and can be in a form of butyl rubber or halobutyl rubber such as, for example, bromobutyl rubber. For example, see U.S. Pat. No. 3,808,177. Butyl rubber is an isobutylene copolymer with a small amount of isoprene which typically contains only from about 0.5 to about 5 weight percent units derived from isoprene. Butyl rubber, while containing a minor amount of units derived from a diene such as, for example isoprene, is not considered herein as being a diene-based rubber since it contains less than 10 percent of its content derived form a diene monomer and, therefore, sulfur vulcanizes at a much slower rate than diene-based elastomers which contain at least, for example, 30 percent of their elastomer content derived from diene monomers. Such innerliner concept is well known to those skilled in such art.

For this invention, it is desired to provide a butyl, or halobutyl, based rubber composition which has good handling, or processing, characteristics in its uncured condition to aid in its preparation in a form of a sheet, or strip, and the handling of the strip in the preparation of a tire assembly with the sheet as an innerliner, followed by enhanced green strength and flow of the rubber composition itself for better processing and aged flex performance and aged adhesion properties for the cured innerliner composition for improved innerliner physical performance.

In the description of this invention, the term “phr” where used herein, and according to conventional practice, refers to “parts of a respective material per 100 parts by weight of rubber, or elastomer”.

In the description of this invention, the terms “rubber” and “elastomer” where used herein, may be used interchangeably, unless otherwise prescribed. The terms “rubber composition”, “compounded rubber” and “rubber compound”, where used herein, are used interchangeably to refer to “rubber which has been blended or mixed with various ingredients and materials” and such terms are well known to those having skill in the rubber mixing or rubber compounding art.

The term “carbon black” as used herein means “carbon blacks having properties typically used in the reinforcement of elastomers, particularly sulfur-curable elastomers”.

A reference to an elastomer's Tg refers to its glass transition temperature which can conveniently be determined by a differential scanning calorimeter at a heating rate of 10° C. per minute.

### SUMMARY AND PRACTICE OF THE INVENTION

In accordance with this invention, a pneumatic tire is provided which contains an air/moisture vapor permeation prevention layer (innerliner), preferably on its inner surface, comprised of, based upon 100 parts by weight of rubber (phr),
(A) 100 parts by weight of at least one isobutylene based copolymer selected from:
   (1) copolymer comprised of isobutylene and isoprene which contains from about 0.5 to about 5 weight percent units derived from isoprene (referred to herein as butyl rubber),
   (2) halogenated copolymer comprised of isobutylene and isoprene which contains from about 0.5 to about 5 weight percent units derived from isoprene wherein said copolymer is halogenated with chlorine or bromine (referred to herein as chlorobutyl and bromobutyl rubber, respectively), and
   (3) brominated copolymer of isobutylene and paramethyl styrene;
(B) from 30 to about 70 phr of reinforcing filler as:
   (1) about 10 to about 30 phr of rubber reinforcing carbon black, and
   (2) about 30 to about 60 phr of a particulate synthetic amorphous precipitated silica (precipitated aggregates of primary silica particles), whereas, insofar as said rubber reinforcing carbon black and said precipitated silica is concerned, said precipitated silica is in the majority; and
(C) a coupling agent having a moiety reactive with hydroxyl groups (e.g. silanol groups) on the surface of said precipitated silica and another moiety interactive with said isobutylene based copolymer(s).

Preferably, said innerliner layer has a thickness in a range of about 2.5 to about 6 mm.

A significant aspect of the invention is the use of a particulate precipitated silica as the major reinforcing agent in an isobutylene based copolymer rubber, together with a coupling agent and together with a minor amount of reinforcing carbon black.

It is considered herein that the addition of the dispersion of the precipitated silica can act to increase green strength for better processing of the uncured rubber composition and increase aged flex performance of the cured rubber composition. Additionally, the type of silica coupler incorporated in the formulation is considered herein to be a significant aspect, as sell as its method of incorporation (e.g. mixing) into the rubber composition.

In particular, a process of preparation of the innerliner strip, its incorporation into the tire assembly and the curing of the tire assembly is provided as:

A process of preparing a pneumatic tire which comprises:
(A) thermomechanically mixing in at least one preparatory (non-productive) mixing step in an internal rubber mixer, in the absence of sulfur and peroxide curatives and in the absence of silica coupling agent, at a temperature in a range of from about 140° C. to about 180° C.:
   (1) 100 parts by weight of at least one isobutylene based copolymer elastomer selected from:
      (a) copolymer comprised of isobutylene and isoprene which contains from about 0.5 to about 5 weight percent units derived from isoprene (referred to herein as butyl rubber),
      (b) halogenated copolymer comprised of isobutylene and isoprene which contains from about 0.5 to about 5 weight percent units derived from isoprene wherein said copolymer is halogenated with chlorine or bromine (referred to herein as chlorobutyl and bromobutyl rubber, respectively), and
      (c) brominated copolymer of isobutylene and paramethyl styrene;
   (2) from 30 to about 70 phr of reinforcing filler as:
      (a) about 10 to about 30 phr of rubber reinforcing carbon black, and
      (b) about 30 to about 60 phr of a particulate synthetic amorphous precipitated silica (precipitated aggregates of primary silica particles), whereas, insofar as said rubber reinforcing carbon black and said precipitated silica is concerned, said precipitated silica is in the majority; and
(B) subsequently blending therewith in a thermomechanically mixing step in an internal rubber mixer at a temperature in a range of from about 90° C. to about 115° C.:
   (1) about 0.3 to about 2 phr of zinc oxide curative (e.g. crosslinking agent) for said isobutylene-based copolymer elastomer, and
   (2) about 0.5 to about 2.5 phr of a bis(3-triethoxysilylpropyl) polysulfide having an average of from about 2 to about 4, alternatively from about 2 to about 2.6, connecting sulfur atoms in its polysulfidic bridge;
wherein the rubber composition is removed from the respective internal rubber mixer and allowed to cool to a temperature below 40° C. between said mixing steps;
(C) processing the prepared rubber composition by extrusion or calendering to from a shaped rubber strip;
(D) building said rubber strip as an innerliner layer into a tire assembly of uncured rubber components;
(E) shaping and curing said tire assembly in a suitable mold at an elevated temperature in a range of from about 140° C. to about 160° C. to form a toroidally shaped pneumatic tire with said innerliner layer as a portion of the pneumatic tire's inner surface; and
(F) removing the shaped and cured pneumatic tire from the mold.

Therefore, it is considered herein that an additional significant aspect of this invention is the preparation of the pneumatic tire with an innerliner layer, or strip, composition itself prepared by use of a combination of the isobutylene copolymer, with its minimal diene derived content, with a precipitated silica reinforcement combined with use of silica coupling agent as a bis(3-triethoxysilylpropyl) polysulfide which is limited to having an average of from about 2 to about 4, alternately only in a range of from about 2 to about 2.6, connecting sulfur atoms in its polysulfidic bridge. Where the bis(3-triethoxysilylpropyl) polysulfide having an average of from only about 2 to about 2.6 connecting sulfur atoms in its polysulfide bridge is used, it is preferably used to the exclusion of (or in the absence of) bis(3-trialkylsilylalkyl) polysulfides, including bis(3-triethoxysilylpropyl) polysulfide, having an average of at 3.4 or more, and preferably an average of 3 or more, connecting sulfur atoms in its polysulfidic bridge.

It is further considered herein that a significant aspect of this invention is the preparation is the preparation of the pneumatic tire with an innerliner layer, or strip, composition itself prepared by use of a combination of the isobutylene copolymer, with its minimal diene derived content, with a precipitated silica reinforcement combined with use of silica coupling agent as a bis(tri-ethoxysilylpropyl) polysulfide which is limited to having an average of only from about 2 to about 2.6 connecting sulfur atoms in its polysulfidic bridge, wherein the silica coupling agent is required to added in the productive mixing step to the exclusion of its addition in a preparatory, non-productive mixing step.

Accordingly, it is considered herein that a new, novel, silica reinforced integral tire innerliner is provided, with the associated pneumatic tire, with improved processing and tire performance properties as compared to simply providing a carbon black reinforced butyl, or halobutyl, rubber-based innerliner.

The building of the pneumatic tire with the innerliner, where the tire would normally include a circumferential tread, two spaced apart beads, an underlying carcass with cord reinforced rubber plies and sidewalls connecting said beads would build as an assembly of the various components and placed in a suitable mold for finally shaping and curing the tire, would be readily understood by one having skill in the pertinent art.

The shaping by extrusion and/or calendaring of the innerliner composition into a strip for application as an innerliner layer of a pneumatic tire assembly would also be readily understood by one having skill in such art.

The preparation of the innerliner composition itself, particularly, by the aforesaid sequential mixing in one or more internal mixers would further be well understood by one having skill in such art. The use of preparatory, or non-productive, mixing steps, or stages, without curatives, or a cure package, followed by a productive mixing step in which curative, or cure package is added is also well understood by one having skill in such art.

An addition of a silica coupling agent in a productive mixing stage has been suggested in various U.S. patents such as, for example, and not intended to be limitive, U.S. Pat. Nos. 5,534,574 and 5,674,932.

In particular, the philosophy of the mixing process is to de-couple the reaction of the siloxy groups of the coupling agent with hydroxyl groups contained on the precipitated silica from the action of the sulfur atoms of the coupling agent.

The reaction of the siloxy groups of the coupling agent with the hydroxyl groups on the precipitated silica is normally considered be a relatively fast reaction which can be caused to occur in a non-productive or subsequent productive mixing stage, depending on whether the coupling agent is added and mixed with the precipitated silica in a non-productive mixing stage or in a subsequent productive mixing stage.

However, the interaction of the sulfur atom(s) of the coupling agent with the elastomer itself is considered herein to be another matter. While the interaction is normally considered to be much slower than the aforesaid reaction of the alkoxy groups of the coupling agent with the hydroxyl groups of the precipitated silica, nevertheless it is desired herein to minimalism such interaction in the preliminary, non-productive, mixing stages in order to not promote an associated increase in rubber viscosity and resultant increase in difficulty in processing of the innerliner rubber composition.

According, for the purposes of this invention, when the bis(3-triethoxysilylpropyl) polysulfide coupling agent is limited to an addition in the productive mixing stage and further limited to having an average of only from about 2 to about 2.6 connecting sulfur atoms in its polysulfidic bridge in which such sulfur atoms are more tightly held by the silica coupling agent as compared to a bis(3-triethoxysilylpropyl) polysulfide which contains an average of 3 or more connecting sulfur atoms in its polysulfidic bridge.

The following example is provided for a further understanding of the invention and is not intended to be limiting. The parts and percentages are by weight unless otherwise specified.

### EXAMPLE I

Samples of bromobutyl rubber-based compositions are prepared for tire innerliner evaluation.

Control Sample A contains only carbon black reinforcement. Sample B contains both carbon black reinforcement and synthetic, amorphous, precipitated silica and a silica coupling agent, wherein the precipitated silica is in the majority insofar as the rubber reinforcing carbon black and precipitated silica are concerned.

The silica coupling agent is a bis(3-triethoxysilylpropyl) polysulfide which contains an average in a range of from about 2 to about 2.6 connecting sulfur atoms in its polysulfidic bridge.

The innerliner rubber composition is prepared by blending the precipitated silica and elastomer in a preparatory (non-productive) mixing stage in an internal rubber mixer followed by mixing the curative and silica coupling agent in a subsequent (productive) mixing stage in an internal rubber mixer.

In particular, the rubber compositions are prepared by mixing the respective ingredients in an internal rubber mixer under high shear mixing conditions in at least one preparatory (non-productive) mixing stage(s) without free sulfur and accelerator curatives for about 4 minutes to a temperature of about 170° C. The rubber composition is removed from the internal rubber mixer, open roll milled, sheeted out and allowed to cool below 40° C. before the next mixing step, or stage.

In a subsequent mixing stage, in an internal rubber mixer, (productive mixing stage), sulfur and accelerator curatives, as well as the silica coupling agent, are mixed with the rubber composition for about 1 minute to a temperature of about 120° C. The rubber composition was then removed from the internal rubber mixer, open roll milled, sheeted out and allowed to cool below 40° C.

The method of preparing rubber compositions via a sequential series of one or more non-productive mixing stages followed by a productive mixing stage is well known to those skilled in such art.

Formulations for Control Sample A and Sample B are shown in the following Table 1.

TABLE 1

| | Control | |
|---|---|---|
| Ingredient | Sample A | Sample B |
| Non-Productive Mixing Step | | |
| Bromobutyl rubber¹ | 100 | 100 |
| Carbon black² | 50 | 15 |
| Zinc oxide | 0.75 | 0.5 |
| Fatty acid³ | 1 | 0.5 |
| Precipitated silica⁴ | 0 | 45 |
| ackifying resin and oils | 14 | 13 |
| Productive Mixing Step | | |
| Sulfur | 0.5 | 0 |
| Coupling agent⁶ | 0 | 1 |
| Cure retarder/accelerator(s)⁷ | 1.3 | 1.2 |
| Zinc oxide curative for the bromobutyl rubber | 0.75 | 0.75 |

¹A brominated butyl rubber as Bromobutyl 2255 ™ from the ExxonMobil Company
²N330, an HAF (high abrasion furnace black) rubber reinforcing carbon black, an ASTM designation
³Primarily, stearic acid
⁴Precipitated silica as Zeopol 877 from the Huber Company
⁵Silica coupler as X266S ™ from the Degussa Company as a composite of bis(3-triethoxysilylpropyl) polysulfide having an average in a range of from about 2.2 to about 2.4 connecting sulfur atoms in its polysulfidic bridge and carbon black in about a 50/50 weight ratio and reported in the Table as the composite which is considered herein to be 50 percent active.
⁶Cure retarder/accelerator combination for the bromobutyl rubber as benzothiazole disulfide and tetramethylthiuramdisulfide

Various uncured (green) and cured properties of the Samples are shown in the following Table 2.

For the cured properties, the respective samples were cured at a temperature of about 150° C. for about 125 minutes. The lengthy cure time was used to simulate the cure experience of very large off-the-road earth mover tires.

For the aged properties, the respective cured samples were aged for 20 days in a hot air oven at 100° C. before testing. The aging of the cured samples was used to simulate severe service conditions which may be experienced by very large off-the-road earth mover tires.

TABLE 2

| | Control | | Percent of |
|---|---|---|---|
| Test/Property | Sample A | Sample B | Sample B |
| Spider compound flow (grams)¹ | 13.3 | 4.9 | 37 |

Green Strength (tensile strengths and elongation of uncured sample)

| | | | |
|---|---|---|---|
| 40 percent elongation (MPa) | 0.445 | 0.542 | 122 |
| 80 percent elongation (MPa) | 0.493 | 0.616 | 125 |
| 120 percent elongation (MPa) | 0.507 | 0.695 | 127 |
| 240 percent elongation (MPa) | 0.503 | 0.810 | 137 |
| 480 percent elongation (MPa) | 0.427 | 0.687 | 161 |
| Ultimate green (uncured) | 0.453 | 1.164 | 257 |
| tensile strength (MPa) | | | |
| Ultimate green (uncured) | 4,587 | 2,890 | 63 |
| elongation (percent) | | | |

Aged ring modulus at 26° C. (MPa)

| | | | |
|---|---|---|---|
| 150 percent elongation | 2.5 | 2.52 | 101 |
| 200 percent elongation | 3.73 | 3.6 | 97 |
| 300 percent elongation | 6.46 | 6.2 | 96 |
| Ultimate aged tensile strength (MPa) | 9.65 | 8.0 | 83 |
| Ultimate aged elongation (percent) | 477 | 401 | 84 |
| Aged energy under modulus vs. | 80.74 | 53.3 | 66 |
| elongation curve (Joules)² | | | |

Aged Hardness (Shore A)

| | | | |
|---|---|---|---|
| At 23° C. | 65.4 | 68.7 | 105 |
| At 100° C. | 52.5 | 56.7 | 108 |

Aged Rebound

| At 23° C. | 12.8 | 12.5 | 98 |
|---|---|---|---|
| At 100° C. | 42.9 | 39.9 | 93 |
| Aged cut growth | 0.074 | 0.04 | 55 |
| at 100° C. (mm/min)² | | | |
| Aged vapor diffusion, or | 0.02 | 0.022 | 111 |
| permeation, (gm/day)³ | | | |
| ¹Reduced spider flow is a desirable property where increased viscosity of the rubber composition is desired. A spider flow test is used by rubber product manufacturers to evaluate potential flowability of rubber compositions during the shaping and curing of a green tire assembly in a suitable mold. Test parameters used | | | |
| # for such test to generate the spider flow numbers (grams) are a 40 minute time period in a mold pre-heated to 135° C. using a 1/8 inch (3.2 mm) diameter orifice and hydraulic pressure of 20,000 pounds (9,080 kg). The mold used was equivalent to a mold manufactured by Brocton Machine, Inc. in Brocton, Massachusetts, U.S.A. per DuPont drawing No. EL-1156. The resultant flow of the rubber sample is measured in grams per extruded test sample. It is believed that such | | | |
| # method of determining a spider flow property rubber sample is well known to those having skill in such art. | | | |
| ²The cut growth test is measure of crack growth during dynamic continuous flexing without relaxation of the sample. The test is sometimes referred to as a DeMattia (Pierced Groove Flex Test). The crack growth of the sample is measured in inches per minute and converted to millimeters (mm) per minute for this Example. The | | | |
| # test is conducted with a DeMattia Flexing Machine ™ at 100° C. The test samples, cured in a DeMattia mold, are of a width of 1.0 inches (2.54 cm) of a size 0.25 × 1.0 × 6.0 inches (0.635 cm × 2.54 cm × 15.24 cm) with a 0.1875 inch (0.4763 cm) diameter half-cylinder groove molded in the center of the sample. The sample is punctured in | | | |
| # the center of the groove with an ASTM piercing tool. The sample is flexed at a constant rate of about 300 +/− cycles per minute. The sample is subjected to a flexing action at the groove from a straight to doubled position. The flexing action induces a tear starting at the puncture and traveling laterally across the groove. Once cracking is detected, the time and crack length are recorded. For example, reference may be made to ASTM D813. | | | |
| ³For the vapor diffusion test, reference is made to ASTM 814. In particular, a thin sheet of the sample having a thickness of 1.016 mm is fitted over a 500 ml diameter open metal container which contains 200 ml of distilled water in which the thus covered container is placed in a hot air oven for 4 days at 180° C. The weight loss of the air/water vapor from the container is measured and reported in units of grams of weight loss each 24 hour period, or grams/day (g/d), | | | |
| # as a measure of the vapor permeability of the sample. | | | |

For the uncured Sample B, as compared to uncured Control Sample A, it can be seen from Table 2 that processability of uncured Sample B is greatly improved as evidenced by a significantly reduced uncured spider flow which is a desirable property for improving handling or uncured sheets, particularly large sheets as would be used for large off-the-road earth mover tire innerliners, during the tire building process, to promote less potential distortion and tearing of the sheet.

Also, for the uncured Sample B, as compared to uncured Control Sample A, it can be seen from Table 2 that uncured Sample B has a significantly increased tensile strength for the same elongation as it is being stretched and, further, has a significantly greater ultimate tensile strength at break. These are desirable properties for improving handling or uncured sheets, particularly large sheets as would be used for large off-the-road earth mover tire innerliners, during the tire building process, to promote less potential distortion and tearing of the sheet.

For the cured Sample B, as compared for the cured Sample A, it can be seen from Table 2 that the aged flex life is improved without a significant effect on aged vapor diffusion, or permeation. This is considered herein to be significant because improved innerliner flex life is envisioned herein to promote increased tire longevity in service.

While certain representative embodiments and details have been shown for the purpose of illustrating the invention, it will be apparent to those skilled in this art that various changes and modifications may be made therein without departing from the spirit or scope of the invention.

1. A pneumatic tire which contains an air/moisture vapor permeation prevention layer on its inner surface, comprised of, based upon 100 parts by weight of rubber (phr),
(A) 100 parts by weight of at least one isobutylene based copolymer selected from:
(1) copolymer comprised of isobutylene and isoprene which contains from about 0.5 to about 5 weight percent units derived from isoprene,
(2) halogenated copolymer comprised of isobutylene and isoprene which contains from about 0.5 to about 5 weight percent units derived from isoprene wherein said copolymer is halogenated with chlorine or bromine, and
(3) brominated copolymer of isobutylene and paramethyl styrene;
(B) from 30 to about 70 phr of reinforcing filler as:
(1) about 10 to about 30 phr of rubber reinforcing carbon black, and
(2) about 30 to about 60 phr of a particulate synthetic amorphous precipitated silica, whereas, insofar as said rubber reinforcing carbon black and said precipitated silica is concerned, said precipitated silica is in the majority; and
(C) a coupling agent having a moiety reactive with hydroxyl groups on the surface of said precipitated silica and another moiety interactive with said isobutylene based copolymer(s).

2. The tire of claim 1 wherein said innerliner layer has a thickness in a range of about 2.5 to about 6 mm.

3. The tire of claim 1 wherein said isobutylene based copolymer is a copolymer comprised of isobutylene and isoprene which contains from about 0.5 to about 5 weight percent units derived from isoprene.

4. The tire of claim 1 wherein said isobutylene based copolymer is a halogenated copolymer comprised of isobutylene and isoprene which contains from about 0.5 to about 5 weight percent units derived from isoprene wherein said copolymer is halogenated with chlorine or bromine,

5. The tire of claim 1 wherein said isobutylene copolymer is a brominated copolymer of isobutylene and paramethyl styrene.

6. A process of preparing a pneumatic tire which comprises:
(A) thermomechanically mixing in at least one preparatory mixing step in an internal rubber mixer, at a temperature in a range of from about 140° C. to about 180° C.:
(1) 100 parts by weight of at least one isobutylene based copolymer elastomer selected from:
(a) copolymer comprised of isobutylene and isoprene which contains from about 0.5 to about 5 weight percent units derived from isoprene,
(b) halogenated copolymer comprised of isobutylene and isoprene which contains from about 0.5 to about 5 weight percent units derived from isoprene wherein said copolymer is halogenated with chlorine or bromine, and
(c) brominated copolymer of isobutylene and paramethyl styrene;
(2) from 30 to about 70 phr of reinforcing filler as:
(a) about 10 to about 30 phr of rubber reinforcing carbon black, and
(b) about 30 to about 60 phr of a particulate synthetic amorphous precipitated silica, whereas, insofar as said rubber reinforcing carbon black and said precipitated silica is concerned, said precipitated silica is in the majority; and
(B) subsequently blending therewith in a thermomechanically mixing step in an internal rubber mixer at a temperature in a range of from about 90° C. to about 115° C.:
(1) about 0.3 to about 2 phr of zinc oxide curative for said isobutylene-based copolymer elastomer, and
(2) about 0.5 to about 2.5 phr of a bis(3-triethoxysilylpropyl) polysulfide having an average of from about 2 to about 4 connecting sulfur atoms in its polysulfidic bridge;
wherein the rubber composition is removed from the respective internal rubber mixer and allowed to cool to a temperature below 40° C. between said mixing steps;
(C) processing the prepared rubber composition by extrusion or calendering to from a shaped rubber strip;
(D) building said rubber strip as an innerliner layer into a tire assembly of uncured rubber components;
(E) shaping and curing said tire assembly in a suitable mold at an elevated temperature in a range of from about 140° C. to about 160° C. to form a toroidally shaped pneumatic tire with said innerliner layer as a portion of the pneumatic tire's inner surface; and
(F) removing the shaped and cured pneumatic tire from the mold.

7. The process of claim 6 wherein said bis(3-triethoxysilylpropyl) polysulfide has an average of from about 2 to about 2.6 connecting sulfur atoms in its polysulfidic bridge.

8. The process of claim 6 wherein said innerliner layer has a thickness in a range of about 2.5 to about 6 mm.

9. The process of claim 6 wherein said isobutylene based copolymer is a copolymer comprised of isobutylene and isoprene which contains from about 0.5 to about 5 weight percent units derived from isoprene.

10. The process of claim 6 wherein said isobutylene based copolymer is a halogenated copolymer comprised of isobutylene and isoprene which contains from about 0.5 to about 5 weight percent units derived from isoprene wherein said copolymer is halogenated with chlorine or bromine,

11. The process of claim 6 wherein said isobutylene copolymer is a brominated copolymer of isobutylene and paramethyl styrene.

12. The process of claim 7 wherein said isobutylene based copolymer is a copolymer comprised of isobutylene and isoprene which contains from about 0.5 to about 5 weight percent units derived from isoprene.

13. The process of claim 7 wherein said isobutylene based copolymer is a halogenated copolymer comprised of isobutylene and isoprene which contains from about 0.5 to about 5 weight percent units derived from isoprene wherein said copolymer is halogenated with chlorine or bromine,

14. The process of claim 7 wherein said isobutylene copolymer is a brominated copolymer of isobutylene and paramethyl styrene;
